(19) United States
(12) Patent Application Publication
(10) Pub. No.: US 2020/0253457 A1
(43) Pub. Date: Aug. 13, 2020

(54) CLEANING POD FOR ELECTRIC BLENDER AND METHOD OF USING THE SAME

(71) Applicant: Imran Jawaid, West Hollywood, CA (US)

(72) Inventor: Imran Jawaid, West Hollywood, CA (US)

(21) Appl. No.: 16/272,608

(22) Filed: Feb. 11, 2019

(51) Int. Cl. A47L 15/44; A47J 43/046; A47J 43/07; C11D 17/00

(52) U.S. Cl. CPC A47L 15/4472; C11D 17/0091; A47J 43/0722; A47J 43/046

(57) ABSTRACT

Disclosed herein is a method of cleaning a jar of an electric blender. The method comprises inserting a cleaning pod into the jar of the electric blender. The cleaning pod comprises at least one cleaning agent comprising a detergent. The method also comprises adding water into the jar to submerse the cleaning pod. The method further comprises rotating blades of the electric blender to mix the detergent of the cleaning pod with the water to form a mixture. The method additionally comprises circulating the mixture in the jar via rotation of the blades to remove residue, on interior surfaces of the jar and/or the blades, from the interior surfaces and to add removed residue to the mixture. The method also comprises removing the mixture from the jar after the residue is added to the mixture.

### FIELD

This disclosure relates generally to electric blenders, and more particularly to products and methods for cleaning an electric blender.

### BACKGROUND

Electric blenders, including food processors, are well known for mixing, chopping, blending, or otherwise processing food and drinks. Conventional electric blenders include a base, having a motor, and a jar, having blades and being selectively mountable to the base. When mounted to the base, the blades of the jar are in co-rotatable engagement with the motor of the base such selective activation of the motor rotates the blades relative to the jar. The rotating blades interact with liquids and/or solids in the jar to process the liquids and/or solids in a manner corresponding with the speed and timing of the blades. The processed liquids and/or solids are poured out of the jar for consumption. However, portions of the liquids and/or solids often stick to the sides of the jar making removal or cleaning of these portions, particularly those portions at the bottom of the jar near the rotatable blades, difficult. If left unattended, some of the processed food can harden or congeal making removal of these portions particularly difficult.

Conventional methods of cleaning, such as hand washing and using an automatic dishwasher, have drawbacks when used to clean the jar of an electric blender. When hand washing, reaching the blades and portions of the jar proximate the blades with a hand-held scouring pad or washcloth for a proper cleaning can be difficult. When using an automatic dishwasher, many dishwashers are incapable of thoroughly reaching and cleaning all inner surfaces of the jar, particularly deep jars. Moreover, the typical washing cycle of a dishwasher is long and the amount of water and detergent used to clean just a jar is excessive and wasteful, especially if the jar is used multiple times a day, for example.

### SUMMARY

The subject matter of the present application has been developed in response to the present state of the art, and in particular, in response to the shortcomings of conventional products and methods for cleaning jars of electric blenders, that have not yet been fully solved. Accordingly, the subject matter of the present application has been developed to provide apparatuses and methods that overcome at least some of the above-discussed shortcomings of prior art products and methods.

Disclosed herein is a cleaning pod for cleaning a jar of an electric blender. The cleaning pod comprises a cleaning body. The cleaning body comprises cleaning agents. The cleaning agents comprise a detergent and a food coloring additive configured to identify completion of a cleaning cycle of the jar. The preceding subject matter of this paragraph characterizes example 1 of the present disclosure.

The cleaning agents further comprise non-soluble agitators made of a solid material. The preceding subject matter of this paragraph characterizes example 2 of the present disclosure, wherein example 2 also includes the subject matter according to example 1, above.

The non-soluble agitators are beads. The preceding subject matter of this paragraph characterizes example 3 of the present disclosure, wherein example 3 also includes the subject matter according to example 2, above.

The cleaning pod further comprises a housing made of a water-soluble film and comprising a first chamber. The first chamber encapsulates an entirety of the cleaning body. The preceding subject matter of this paragraph characterizes example 4 of the present disclosure, wherein example 4 also includes the subject matter according to any one of examples 1-3, above.

The cleaning pod further comprises a second cleaning body comprising at least one cleaning agent. The housing further comprises a second chamber isolated from the first chamber and encapsulating an entirety of the second cleaning body. The cleaning agents of the cleaning body are liquid cleaning agents. The cleaning agent of the second cleaning body is a solid cleaning agent. The preceding subject matter of this paragraph characterizes example 5 of the present disclosure, wherein example 5 also includes the subject matter according to example 4, above.

The cleaning body is anhydrous. The food coloring additive is a powdered food dye. The cleaning body further comprises an adhesion promoter to bind together the detergent and the powdered food dye. The preceding subject matter of this paragraph characterizes example 6 of the present disclosure, wherein example 6 also includes the subject matter according to any one of examples 1-3, above.

The cleaning agents further comprise lemon extract and baking soda. The preceding subject matter of this paragraph characterizes example 7 of the present disclosure, wherein example 7 also includes the subject matter according to any one of examples 1-6, above.

The food coloring additive is a different color than the detergent. The preceding subject matter of this paragraph characterizes example 8 of the present disclosure, wherein example 8 also includes the subject matter according to any one of examples 1-7, above.

Further disclosed herein is a method of cleaning a jar of an electric blender. The method comprises inserting a cleaning pod into the jar of the electric blender. The cleaning pod comprises at least one cleaning agent comprising a detergent. The method also comprises adding water into the jar to submerse the cleaning pod. The method further comprises rotating blades of the electric blender to mix the detergent of the cleaning pod with the water to form a mixture. The method additionally comprises circulating the mixture in the jar via rotation of the blades to remove residue, on interior surfaces of the jar and/or the blades, from the interior surfaces and to add removed residue to the mixture. The method also comprises removing the mixture from the jar after the residue is added to the mixture. The preceding subject matter of this paragraph characterizes example 9 of the present disclosure.

The method further comprises rinsing the interior surfaces of the jar and blades with water after removing the mixture from the jar. The preceding subject matter of this paragraph characterizes example 10 of the present disclosure, wherein example 10 also includes the subject matter according to example 9, above.

The method further comprises drying the interior surfaces of the jar and blades after rinsing the interior surfaces of the jar and blades. The preceding subject matter of this paragraph characterizes example 11 of the present disclosure, wherein example 11 also includes the subject matter according to example 10, above.

The at least one cleaning agent of the cleaning pod further comprises a food coloring additive. Rotating the blades of the electric blender mixes the detergent and the food coloring additive with the water to form the mixture. The mixture is circulated until the food coloring additive is substantially uniformly mixed with the water. The preceding subject matter of this paragraph characterizes example 12 of the present disclosure, wherein example 12 also includes the subject matter according to any one of examples 9-11, above.

Attributes of the food coloring additive are such that uniform mixing of the food coloring additive indicates completion of a predetermined cleaning cycle of the jar of the electric blender. The preceding subject matter of this paragraph characterizes example 13 of the present disclosure, wherein example 13 also includes the subject matter according to example 12, above.

The method further comprises manually stopping circulation of the mixture in the jar by stopping rotation of the blades when, via observation of the mixture through the jar, the food coloring additive is substantially uniformly mixed with the water. The preceding subject matter of this paragraph characterizes example 14 of the present disclosure, wherein example 14 also includes the subject matter according to example 13, above.

The food coloring additive is a different color than the detergent and the water. The preceding subject matter of this paragraph characterizes example 15 of the present disclosure, wherein example 15 also includes the subject matter according to example 14, above.

The food color additive is substantially uniformly mixed with the water when an entirety of the water has a uniform color corresponding with a color of the food color additive. The preceding subject matter of this paragraph characterizes example 16 of the present disclosure, wherein example 16 also includes the subject matter according to any one of examples 12-15 above.

Rotating the blades of the electric blender to mix the detergent of the cleaning pod with the water to form the mixture comprises directly impacting the cleaning pod with the blades, as the blades rotate, to break apart the cleaning pod. The preceding subject matter of this paragraph characterizes example 17 of the present disclosure, wherein example 17 also includes the subject matter according to any one of examples 9-16 above.

The cleaning pod further comprises a housing made of a water-soluble film and comprising a first chamber, wherein the first chamber encapsulates the detergent. The preceding subject matter of this paragraph characterizes example 18 of the present disclosure, wherein example 18 also includes the subject matter according to any one of examples 9-17 above.

The cleaning pod is anhydrous. The cleaning pod comprises an adhesion promoter that binds together the detergent into a fixed shape. The preceding subject matter of this paragraph characterizes example 19 of the present disclosure, wherein example 19 also includes the subject matter according to any one of examples 9-17 above.

The cleaning pod further comprises non-soluble beads. Rotating the blades of the electric blender further mixes the detergent and the non-soluble beads with the water. Circulating the mixture further comprises impacting the residue with the non-soluble beads of the mixture. The preceding subject matter of this paragraph characterizes example 20 of the present disclosure, wherein example 20 also includes the subject matter according to any one of examples 9-19 above.

The described features, structures, advantages, and/or characteristics of the subject matter of the present disclosure may be combined in any suitable manner in one or more examples, embodiments, or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular example, embodiment, or implementation. In other instances, additional features and advantages may be recognized in certain examples, embodiments, and/or implementations that may not be present in all examples, embodiments, or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples or embodiments that are illustrated in the appended drawings. Understanding that these drawings depict only typical examples or embodiments of the subject matter and are not therefore to be considered to be limiting of its scope, the subject matter will be described and explained with additional specificity and detail through the use of the drawings, in which:

FIG. 1 is a front view of an electric blender, according to a conventional configuration;

FIG. 2 is a perspective view of a cleaning pod, according to one or more examples of the present disclosure;

FIG. 3 is a cross-sectional side view of the cleaning pod of FIG. 1, taken along the line 3-3 of FIG. 2, according to one or more examples of the present disclosure;

FIG. 4A is a cross-sectional side view of the cleaning pod of FIG. 1, taken along the line 3-3 of FIG. 2, according to one or more examples of the present disclosure;

FIG. 4B is a cross-sectional side view of a cleaning pod, taken along a line similar to the line 3-3 of FIG. 2, according to one or more examples of the present disclosure;

FIG. 5 is a front view of the electric blender of FIG. 1, shown with residue on a jar of the electric blender, according to one or more examples of the present disclosure;

FIG. 6 is a front view of the electric blender of FIG. 5, shown with the cleaning pod of FIG. 2 falling into the jar of the electric blender, according to one or more examples of the present disclosure;

FIG. 7 is a front view of the electric blender of FIG. 6, shown with the cleaning pod at a bottom of the jar adjacent blades of the jar, according to one or more examples of the present disclosure;

FIG. 8 is a front view of the electric blender of FIG. 7, shown with water added into the jar, according to one or more examples of the present disclosure;

FIG. 9 is a front view of the electric blender of FIG. 8, shown with the blades circulating a mixture in the jar, according to one or more examples of the present disclosure;

FIG. 10 is a front view of the electric blender of FIG. 9, shown with the mixture removed from the jar, according to one or more examples of the present disclosure;

FIG. 11 is a perspective view of a cleaning pod, according to one or more examples of the present disclosure;

FIG. 12 is a schematic view of a cleaning pod, according to one or more examples of the present disclosure;

FIG. 13 is a front view of the electric blender of FIG. 1, shown with residue on a jar of the electric blender, according to one or more examples of the present disclosure;

FIG. 14 is a front view of the electric blender of FIG. 13, shown with the cleaning pod of FIG. 11 falling into the jar of the electric blender, according to one or more examples of the present disclosure;

FIG. 15 is a front view of the electric blender of FIG. 14, shown with the cleaning pod at a bottom of the jar adjacent blades of the jar, according to one or more examples of the present disclosure;

FIG. 16 is a front view of the electric blender of FIG. 15, shown with water added into the jar, according to one or more examples of the present disclosure;

FIG. 17 is a front view of the electric blender of FIG. 16, shown with the blades circulating a mixture in the jar, according to one or more examples of the present disclosure;

FIG. 18 is a front view of the electric blender of FIG. 17, shown with the mixture removed from the jar, according to one or more examples of the present disclosure; and

FIG. 19 is a schematic flow diagram of a method of cleaning a jar of an electric blender, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more embodiments of the present disclosure, however, absent an express correlation to indicate otherwise, an implementation may be associated with one or more examples.

Disclosed herein is a cleaning pod configured to clean a jar of an electric blender and a corresponding method of using the cleaning pod to clean a jar of an electric blender. The cleaning pod and method of using the cleaning pod help to overcome the shortcomings of conventional products and methods of cleaning jars of electric blenders. More specifically, the cleaning pod and corresponding method of use facilitate removal of food and/or liquid from the sides of the jar in a productive and efficient manner without requiring manual cleaning or excess water and time associated with dishwashers. Accordingly, a user can utilize the cleaning pod of the present disclosure to clean the jar of an electric blender quickly and efficiently after each use of the jar.

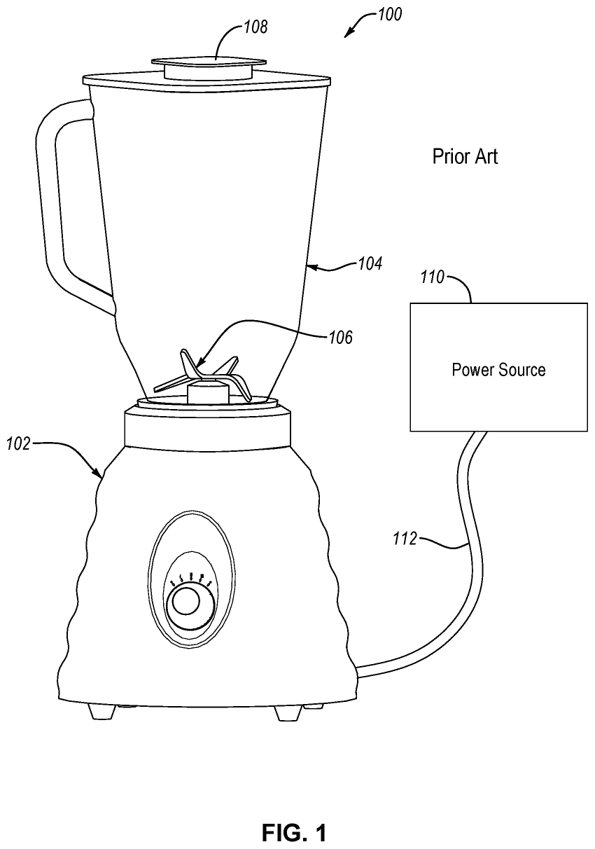

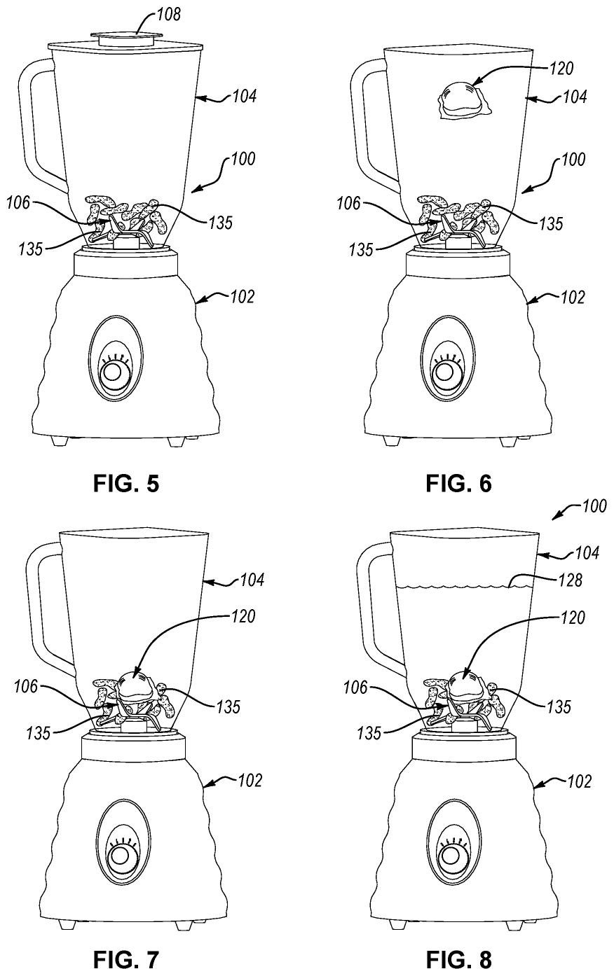

Referring to FIG. 1, an electric blender 100, according to a conventional configuration, includes a base 102 and a jar 104 that is selectively mountable to the base 102. The base 102 includes a motor (not shown) that is selectively controlled by operation of controls, such as buttons, dials, switches, and the like, that are user engageable and built into the base 102. The controls control the supply of power through a power chord 112 from a power source 110. The jar 104 includes blades 106, within the jar 104, that are configured to rotate relative to the jar 104. When mounted to the base 102, the motor of the base 102 is co-rotatably engaged with the blades 106. Selective activation of the motor by a user causes the motor to rotate the blades 106 relative to the jar 104. Rotating the blades 106 causes the blades 106 to interact with (e.g., mix, chop, blend, process, etc.) whatever liquid or solid is retained within the jar 104. To prevent inadvertent departure of the processed liquid or solid from the jar 104 while interacting with the blades 106, a lid 108 is releasably secured to the jar 104 over a top opening in the jar 104. Referring to FIG. 5, even after pouring the processed liquid or solid out of the jar 104, often, some residue 135 can be left on the inside of the jar 104 and the blades 106. As used herein, the electric blender 100 includes any beverage or food processing device with a motorized base and a food container, with blades, mountable on the motorized base. Accordingly, as used herein, a conventional food processor is considered an electric blender 100 and can be used interchangeably with an electric blender.

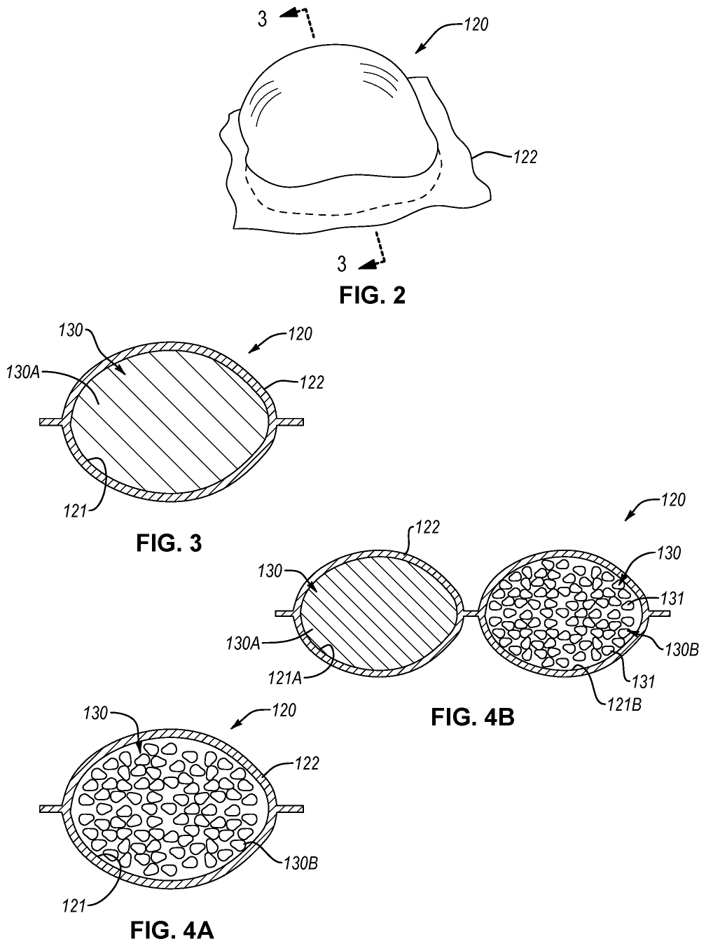

According to one example, shown in FIG. 2, a cleaning pod 120 is configured to help remove the residue 135 from the jar 104. The cleaning pod 120 includes a housing 122 that encapsulates at least one chamber 121. The housing 122 is made of a water-soluble film, such as a polyvinyl alcohol (PVA) film, that will dissolve when immersed in water. The cleaning pod 120 further includes a cleaning body 130 entirely contained (e.g., hermetically sealed) within the chamber 121 by the housing 122. The cleaning body 130 is any one or more of various liquid cleaning agents or solid cleaning agents configured to facilitate cleaning of the jar 104. In some examples, the cleaning pod 120 includes two or more cleaning bodies 130, as shown in FIG. 4B. As used herein, a cleaning pod is a self-contained, portable unit that comprises at least one cleaning agent.

Referring to FIG. 3, in some examples, the cleaning body 130 of the cleaning pod 120 is a liquid cleaning body 130A. In some implementations, the liquid cleaning body 130A includes a single type of liquid cleaning agent, such as a liquid detergent. However, in other implementations, the liquid cleaning body 130A includes at least two types of intermixed liquid cleaning agents. For example, in some implementations, the liquid cleaning body 130A includes at least two of a liquid detergent, a lemon extract, a vinegar, and a food coloring additive. In one implementation, the liquid cleaning body 130A includes all of the liquid detergent, the lemon extract, the vinegar, and the food coloring additive. The liquid detergent functions to clean the inside of the blender. The vinegar helps to provide additional cleaning and to improve the appearance of the blender. The lemon extract promotes additional cleaning and improves the smell of the blender. The food coloring additive provides an indicator of mixing of the liquid cleaning body 130A with the water 128 in the mixture 129 (see, e.g., FIG. 8) in the jar 104, which helps to determine the level of completion of the cleaning of the jar 104 by the cleaning body 130. For example, a fully mixed food coloring additive indicates completion of a predetermined cleaning cycle of the jar 104 by the cleaning pod 120. The liquid cleaning agents of the cleaning pod 120 are water soluble.

Referring to FIG. 4A, in some examples, the cleaning body 130 of the cleaning pod 120 is a solid cleaning body 130B. In some implementations, the solid cleaning body 130B includes a single type of solid cleaning agent, such as a dry detergent powder, formed into a plurality of pellets 131. However, in other implementations, the liquid cleaning body 130A includes at least two types of intermingled solid cleaning agents with each type of agent formed into a plurality of pellets 131. For example, in some implementations, the solid cleaning body 130B includes at least two of a dry detergent powder, agitators, baking soda, lemon extract powder, and powdered food dye. The agitator can be any of various solid materials configured to agitate residues on the surfaces of the jar 104 to facilitate removal of the residues from the jar 104. In one example, the agitator is a plurality of beads, which can be water-soluble or non-soluble beads. Generally, in some examples, the solid cleaning body 130B helps to improve agitation by facilitating dissolution of hardened residues. The powdered food dye provides an indicator of mixing of the solid cleaning body 130B with the water 128 in the mixture 129 (see, e.g., FIG. 8) in the jar 104, which, as identified above, helps to determine the level of completion of the cleaning of the jar 104 by the cleaning body 130. The solid cleaning agents of the cleaning pod 120 are water soluble.

As shown in FIG. 4B, according to certain examples, the housing 122 encapsulates at least two chambers. In one example, the housing 122 encapsulates a first chamber 121A and a second chamber 121B. The first chamber 121A is isolated from the second chamber 121B such that contents within the first chamber 121A do not contact or engage with the contents of the second chamber 121B until the water-soluble film of the housing 122 at least partially dissolves in water. Each one of the first chamber 121A and the second chamber 121B contains a separate cleaning body 130. In other words, the first chamber 121A and the second chamber 121B helps to separate the respective cleaning bodies 130 until the water-soluble film at least partially dissolves.

The cleaning body 130 in the first chamber 121A is different than the cleaning body 130 in the second chamber 121B. In one example, the cleaning body 130 in the first chamber 121A is a liquid cleaning body 130A and the cleaning body 130 in the second chamber 121B is a solid cleaning body 130B. The liquid cleaning body 130A can include a single type of liquid cleaning agent or multiple types of liquid cleaning agents intermixed together. The solid cleaning body 130B can include a single type of solid cleaning agent or multiple types of solid cleaning agents intermingled together. According to another example, the cleaning body 130 in the first chamber 121A is a liquid cleaning body 130A of at least a first type and the cleaning body 130 in the second chamber 121B is a liquid cleaning body 130A of at least a second type. In yet other examples, the cleaning body 130 in the first chamber 121A is a solid cleaning body 130B of at least a first type and the cleaning body 130 in the second chamber 121B is a solid cleaning body 130B of at least a second type. Although the cleaning pod 120 in FIG. 4B has two chambers, in other examples, the cleaning pod 120 has three or more chambers each with a different cleaning body therein.

Referring to FIGS. 5-10 and 19, according to some examples, disclosed herein is a method 300 of using the cleaning pod 120 to clean the jar 104 of the n. Of course, in other examples, the method 300 can be executed to use the cleaning pod 120 to clean a jar of another type of blender, including food processors. The method 300 begins after a user has finished using the electric blender 100 for processing a food or beverage and after the contents have been removed from the jar 104 for consumption, some portions of the food or beverage (e.g., the residue 135) is left on the inside surface of the jar 104 and/or the blades 106, as is shown in FIG. 5.

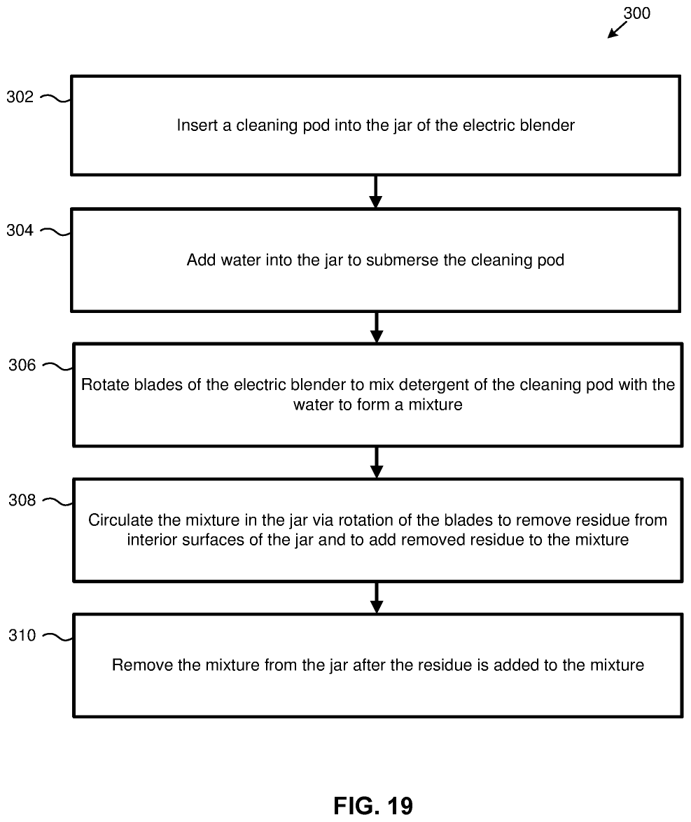

With the lid 108 removed from the jar 104, the method 300 includes (block 302) inserting (e.g., dropping) the cleaning pod 120 into the jar 104, through the top opening in the jar 104, as particularly shown in FIGS. 6 and 19. The cleaning pod 120 falls to the bottom of the jar 104 adjacent or in contact with the blades 106, assuming the jar 104 is substantially vertically oriented, as shown in FIG. 7. Depending on the configuration of the blades 106, the cleaning pod 120 may fall into a position between adjacent blades 106. Referring particularly to FIGS. 8 and 19, the method 300 additionally includes (block 304) adding water 128 to the jar 104 to completely immerse or submerge the cleaning pod 120, at the bottom of the jar 104, in the water 128. In some examples, enough water 128 is added to completely immerse or submerge the blades 106 in the water 128. In certain examples, enough water 128 is added to the jar 104 to fill about half of the jar 104. Additionally, the water 128 added to the jar 104 is warm or hot water in some examples to help promote dissolving of the soluble film of the housing 122 of the cleaning pod 120 and removal of the residue 135 from the lid 108. As soon as the water 128 is added to the jar 104, the soluble film of the housing 122 of the cleaning pod 120 starts to dissolve. The above steps of the method 300 can be performed with the jar 104 dismounted from or mounted to the base 102.

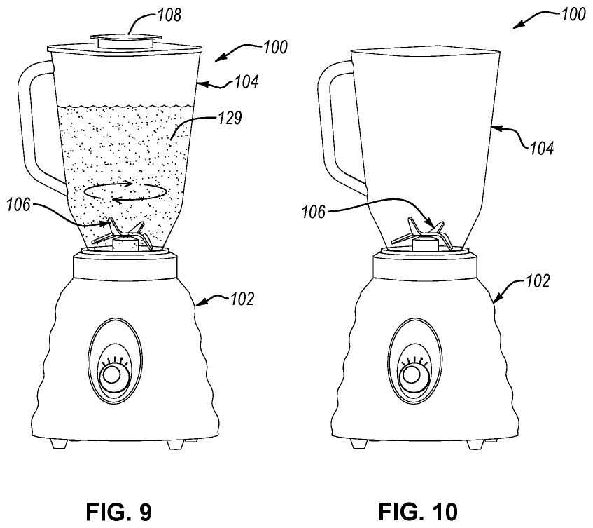

Referring to FIGS. 9 and 19, with the jar 104 mounted to the base 102, and preferably with the lid 108 covering the top opening of the jar 104, the method 300 further includes (block 306) rotating the blades 106 of the jar 104 by selectively operating the electric blender 100 via the controls of the electric blender 100. Generally, rotation of the blades 106 mixes the cleaning body 130 or cleaning bodies 130 of the cleaning pod 120 in the water 128 to form a mixture 129 of water, cleaning agent(s), and residue 135 removed from the inner surface and blades 106 of the jar 104. Depending on the state of dissolution of the cleaning pod 120, rotation of the blades 106 either begins mixing the cleaning agent(s) contained in the cleaning body 130 or cleaning bodies 130 of the cleaning pod 120 right away or helps break up the water-soluble film of the housing 122 of the cleaning pod 120, by directly impacting the cleaning pod 120, to promote dissolution of the film and release of the cleaning agent(s).

After the cleaning agent(s) is released from the cleaning pod 120, the blades 106 are continually rotated and the cleaning agent(s) is continually mixed with the water 128 for a time sufficient to remove the residue 135 from the surfaces of the jar 104. The rotation of the blades induces high-speed circulation of the cleaning agent(s) and the water, which facilitates the mixing of the cleaning agent(s) and the water. Moreover, the cleaning properties of the cleaning agent(s), in conjunction with the violent and high-speed circulating motion of the water 128 generated by the blades 106, quickens the release of the residue 135 from the surfaces of the jar 104 compared to manual cleaning and dishwasher techniques. Accordingly, as shown in FIGS. 9 and 19, the method 300 further includes (block 308) circulating the mixture 129 in the jar 104 via rotation of the blades 106 to remove residue 135 from interior surfaces of the jar 104 and to add removed residue to the mixture 129. In some examples, depending on the rotational speed of the blades 106, the blades 106 are rotated for between 10 seconds and 60 seconds. According to one example, the blades 106 are rotated for approximately 30 seconds. In yet another example, the blades 106 are rotated until the mixture 129 is fully mixed, which corresponds with the mixture 129 having a uniform, consistent color corresponding with a food coloring additive in some implementations.

According to one example, the time sufficient to remove the residue 135 from the surfaces of the jar 104 corresponds with substantially uniform mixing of a food coloring additive of the cleaning pod with the water. In an example, the food color additive is substantially uniformly mixed with the water when an entirety of the water has a uniform color corresponding with a color of the food color additive. According to certain examples, the attributes (e.g., quantity, solubility, percent composition relative to the water, etc.) of the food coloring additive are such that uniform mixing of the food coloring additive indicates completion of a predetermined cleaning cycle of the jar 104 of the electric blender 100, which corresponds with removal of the residue 135 from the surfaces of the jar 104. In some examples, uniform mixing of the food coloring additive with the water is determined through manual visual observation of the color of the mixture, by looking through the jar 104. The food coloring additive is a different color than the detergent and the water to provide a clear indication of the mixing of the food coloring additive with the water independent of the detergent.

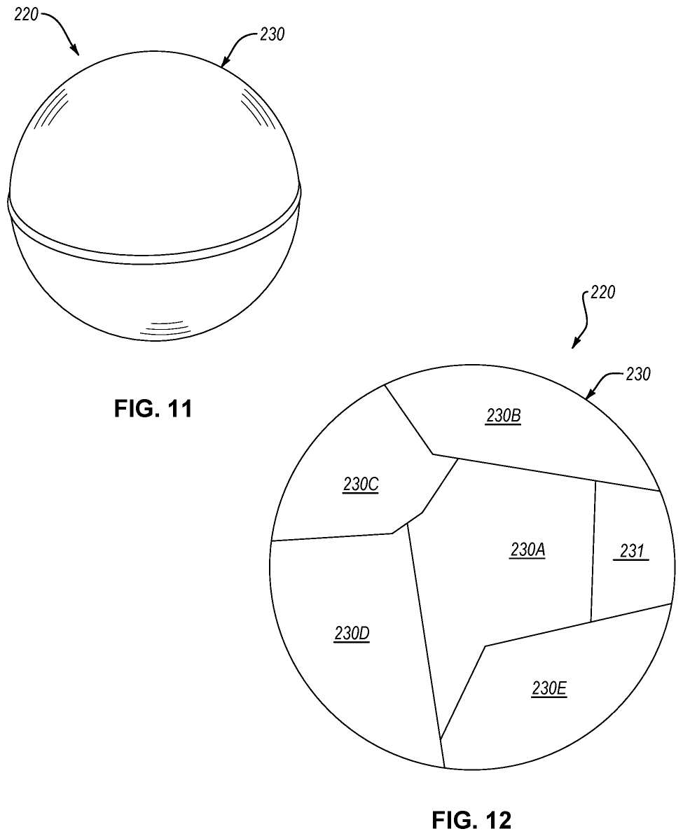

After the cleaning cycle is completed (e.g., after the blades 106 have been rotated for a time sufficient to remove the residue 135 from the surfaces of the jar 104 and into the mixture 129), the method 300 further includes stopping rotation of the blades 106 and (block 310) removing the mixture 129 from the jar 104. Because the residue 135 has been released into the mixture 129, removing the mixture 129 promotes removal of the residue 135 from the jar 104, as shown in FIG. 10. In some examples, the method 300 additionally includes rinsing the inside of the jar 104 with clean water, after removal of the mixture 129, to help ensure removal of the residue 135 from the jar 104. The method 300 further includes wiping down the inside surfaces of the jar 104 with a paper towel or rag to more quickly dry the interior surfaces of the jar 104.

According to another example, shown in FIG. 11, a cleaning pod 220 is configured to help remove the residue 135 from the jar 104. The cleaning pod 220 includes anhydrous materials packed together to form a desired shape. In the illustrated example, the desired shape is a ball or sphere. However, in other examples, the shape of the cleaning pod 220 is a non-spherical shape. The anhydrous materials form a solid cleaning body 230 that includes at least one type of solid cleaning agent and an adhesion promoter 231. The solid cleaning agent is any one of various solid cleaning agents configured to facilitate cleaning of the jar 104, such as dry detergent powder, lemon extract, baking soda, food dye, and beads. The adhesion promoter 231 helps to bind the solid cleaning agents together until the cleaning pod 220 is placed and dissolved in water. The solid cleaning agents of the cleaning pod 220 are water soluble.

In some examples, the solid cleaning body 230 includes only one solid cleaning agent. However, in other examples, the solid cleaning body 230 includes a combination of two or more solid cleaning agents. In one example, as shown schematically in FIG. 12, in addition to the adhesion promoter 231, the solid cleaning body 230 of the cleaning pod 220 includes a first solid cleaning agent 230A, a second solid cleaning agent 230B, a third solid cleaning agent 230C, a fourth solid cleaning agent 230D, and a fifth solid cleaning agent 230E. Although shown as occupying separate and distinct regions of the cleaning pod 220, in practical applications, the various cleaning agents would be intermingled with each other, uniformly in some instances, such that the cleaning pod 220 would not have separate and distinct regions of agents. According to an example, the first solid cleaning agent 230A is a dry detergent powder, the second solid cleaning agent 230B is a lemon extract, the third solid cleaning agent 230C is baking soda, the fourth solid cleaning agent 230D is a powdered food dye, and the fifth solid cleaning agent 230E are beads.

The cleaning pod 220 is made by mixing the solid cleaning agents of the solid cleaning body 230 with the adhesion promoter 231 and water. The mixture is formed into a desired shape and allowed to dry. The dried mixture forms the cleaning pod 220.

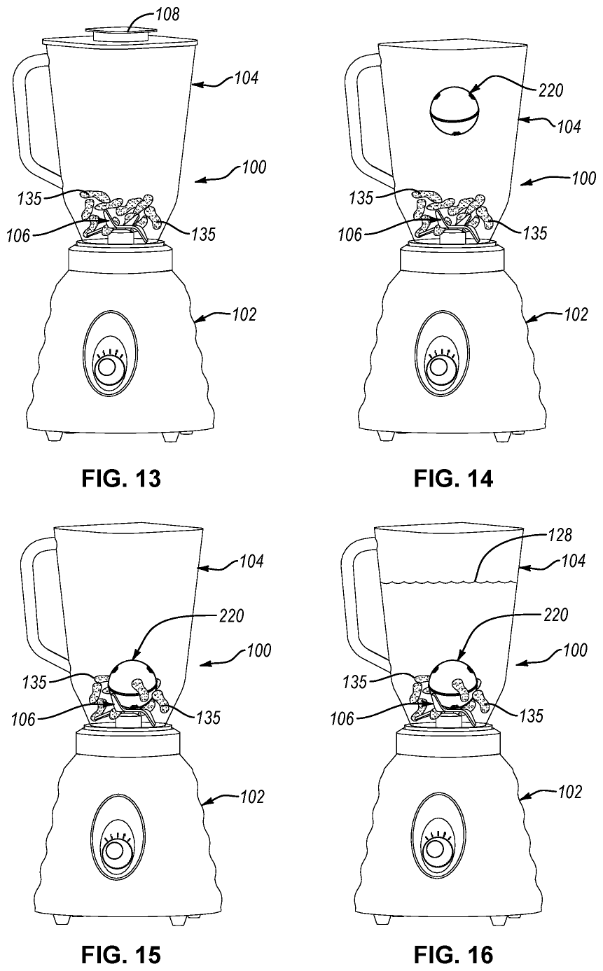

Referring to FIGS. 13-18, according to some examples, disclosed herein is a method of using the cleaning pod 220 to clean the jar 104 of the electric blender 100. Of course, in other examples, the method can be executed to use the cleaning pod 220 to clean a jar of another type of blender or a food processor. The method is analogous to the method 300, shown partially in FIG. 19. In fact, the method 300 can be used to clean the jar 104 of the electric blender 100 using the cleaning pod 220, instead of the cleaning pod 120. The method begins after a user has finished using the electric blender 100 for processing a food or beverage and after the contents have been removed from the jar 104 for consumption, some portions of the food or beverage (e.g., the residue 135) is left on the inside surface of the jar 104 and/or the blades 106, as is shown in FIG. 13.

With the lid 108 removed from the jar 104, the method includes inserting (e.g., dropping) the cleaning pod 220 into the jar 104, through the top opening in the jar 104, as shown in FIG. 14. The cleaning pod 220 falls to the bottom of the jar 104 adjacent or in contact with the blades 106, assuming the jar 104 is substantially vertically oriented, as shown in FIG. 15. Depending on the configuration of the blades 106, the cleaning pod 220 may fall into a position between adjacent blades 106. Referring to FIG. 16, the method additionally includes adding water 128 to the jar 104 to completely immerse or submerge the cleaning pod 220, at the bottom of the jar 104, in the water 128. In some examples, enough water 128 is added to completely immerse or submerge the blades 106 in the water 128. In certain examples, enough water 128 is added to the jar 104 to fill about half of the jar 104. Additionally, the water 128 added to the jar 104 is warm or hot water in some examples to help promote dissolving of the solid cleaning agents of the cleaning pod 220 and removal of the residue 135 from the lid 108. As soon as the water 128 is added to the jar 104, the solid cleaning agents of the cleaning pod 120 start to break apart from each other and dissolve into the water 128. The above steps of the method can be performed with the jar 104 dismounted from or mounted to the base 102.

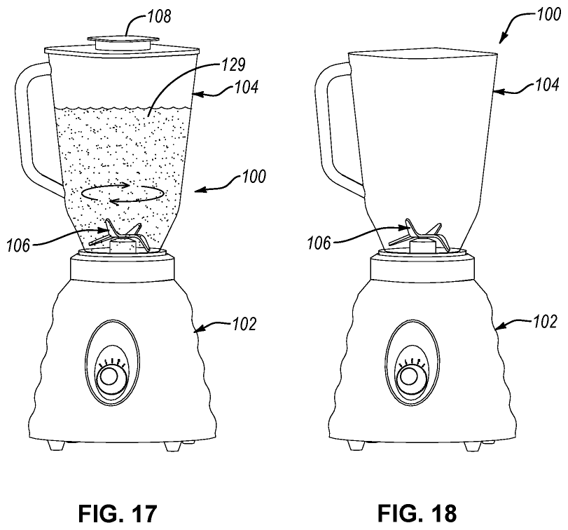

Referring to FIG. 17, with the jar 104 mounted to the base 102, and preferably with the lid 108 covering the top opening of the jar 104, the method further includes rotating the blades 106 of the jar 104 by selectively operating the electric blender 100 via the controls of the electric blender 100. Generally, rotation of the blades 106 mixes the solid cleaning agent(s) of the solid cleaning body 230 of the cleaning pod 220 in the water 128 to form the mixture 129 of water, solid cleaning agent(s), and residue 135 removed from the inner surface and blades 106 of the jar 104. The blades 106 are continually rotated and the cleaning agent(s) are continually mixed with the water 128 for a time sufficient to remove the residue 135 from the surfaces of the jar 104. In some examples, depending on the rotational speed of the blades 106, the blades 106 are rotated for between 10 seconds and 60 seconds. According to one example, the blades 106 are rotated for approximately 30 seconds. In yet another example, the blades 106 are rotated until the mixture 129 is fully mixed, which corresponds with the mixture 129 having a uniform, consistent color corresponding with a food dye in some implementations.

After the cleaning cycle is completed, the method further includes stopping rotation of the blades 106, removing the mixture 129 from the jar 104, rinsing the inside of the jar 104 with clean water, and wiping down the inside surfaces of the jar 104 with a paper towel or rag (see, e.g., FIG. 18).

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. A cleaning pod for cleaning ajar of an electric blender, the cleaning pod comprising:
a cleaning body, comprising cleaning agents, wherein the cleaning agents comprise:
a detergent; and
a food coloring additive configured to identify completion of a cleaning cycle of the jar.

2. The cleaning pod according to claim 1, wherein the cleaning agents further comprise non-soluble agitators made of a solid material.

3. The cleaning pod according to claim 2, wherein the non-soluble agitators are beads.

4. The cleaning pod according to claim 1, further comprising a housing made of a water-soluble film and comprising a first chamber, wherein the first chamber encapsulates an entirety of the cleaning body.

5. The cleaning pod according to claim 4, further comprising a second cleaning body comprising at least one cleaning agent, wherein:
the housing further comprises a second chamber isolated from the first chamber and encapsulating an entirety of the second cleaning body;
the cleaning agents of the cleaning body are liquid cleaning agents; and
the cleaning agent of the second cleaning body is a solid cleaning agent.

6. The cleaning pod according to claim 1, wherein:
the cleaning body is anhydrous;
the food coloring additive is a powdered food dye; and
the cleaning body further comprises an adhesion promoter to bind together the detergent and the powdered food dye.

7. The cleaning pod according to claim 1, wherein the cleaning agents further comprise:
lemon extract; and
baking soda.

8. The cleaning pod according to claim 1, wherein the food coloring additive is a different color than the detergent.

9. A method of cleaning a jar of an electric blender, the method comprising:
inserting a cleaning pod into the jar of the electric blender, wherein the cleaning pod comprises at least one cleaning agent comprising a detergent;
adding water into the jar to submerse the cleaning pod;
rotating blades of the electric blender to mix the detergent of the cleaning pod with the water to form a mixture;
circulating the mixture in the jar via rotation of the blades to remove residue, on interior surfaces of the jar and/or the blades, from the interior surfaces and to add removed residue to the mixture; and
removing the mixture from the jar after the residue is added to the mixture.

10. The method according to claim 9, further comprising rinsing the interior surfaces of the jar and blades with water after removing the mixture from the jar.

11. The method according to claim 10, further comprising drying the interior surfaces of the jar and blades after rinsing the interior surfaces of the jar and blades.

12. The method according to claim 9, wherein:
the at least one cleaning agent of the cleaning pod further comprises a food coloring additive;
rotating the blades of the electric blender mixes the detergent and the food coloring additive with the water to form the mixture; and
the mixture is circulated until the food coloring additive is substantially uniformly mixed with the water.

13. The method according to claim 12, wherein attributes of the food coloring additive are such that uniform mixing of the food coloring additive indicates completion of a predetermined cleaning cycle of the jar of the electric blender.

14. The method according to claim 13, further comprising manually stopping circulation of the mixture in the jar by stopping rotation of the blades when, via observation of the mixture through the jar, the food coloring additive is substantially uniformly mixed with the water.

15. The method according to claim 14, wherein the food coloring additive is a different color than the detergent and the water.

16. The method according to claim 12, wherein the food color additive is substantially uniformly mixed with the water when an entirety of the water has a uniform color corresponding with a color of the food color additive.

17. The method according to claim 9, wherein rotating the blades of the electric blender to mix the detergent of the cleaning pod with the water to form the mixture comprises directly impacting the cleaning pod with the blades, as the blades rotate, to break apart the cleaning pod.

18. The method according to claim 9, wherein the cleaning pod further comprises a housing made of a water-soluble film and comprising a first chamber, wherein the first chamber encapsulates the detergent.

19. The method according to claim 9, wherein:
the cleaning pod is anhydrous; and
the cleaning pod comprises an adhesion promoter that binds together the detergent into a fixed shape.

20. The method according to claim 9, wherein:
the cleaning pod further comprises non-soluble beads;
rotating the blades of the electric blender further mixes the detergent and the non-soluble beads with the water; and
circulating the mixture further comprises impacting the residue with the non-soluble beads of the mixture.
